(19) United States
(12) Patent Application Publication
(10) Pub. No.: US 2002/0134121 A1
(43) Pub. Date: Sep. 26, 2002

(54) Combination lock

(76) Inventor: Lambert Kuo, Tainan (TW)

Correspondence Address: Hedman, Gibson & Costigan, P.C., 1185 Avenue of the Americas, New York, NY, 10036-2646, US

(21) Appl. No.: 09/812,625

(22) Filed: Mar. 20, 2001

(51) Int. Cl. E05B 37/02

(52) U.S. Cl. 70/312

(57) ABSTRACT

A combination lock with a simplified structure is disclosed. The lock includes a male body having an outwardly extending bolt with an axial row of projecting bits formed thereon, and a female body having an outwardly extending tube with an axial narrow opening defined therein. The tube is used for receiving the outwardly extending bolt of the male body in a way of allowing the bits to be protruded therefrom through the axial narrow opening. The tube further has a plurality of axial grooves defined in an outer periphery thereof. A set of dials is mounted around the tube of the female body. Each of the dials has a dial ring, and a hairspring carried on the dial ring and having a pair of curved portions extending inward to engage two of the axial grooves of the tube.

### BACKGROUND OF THE INVENTION

1. Field of the Invention

The present invention relates to a combination lock and, more particularly, to a combination lock with a simplified structure.

2. Description of Related Art

Many combination locks are known in the art. FIG. 4 illustrates one which includes a wire rope (30) with a female body (31) at one end and a male body (32) at the other. The male body (32) has an outwardly extending bolt (321) with an axial row of bits (322) formed thereon, while the female body (31) has an outwardly extending tube (311) with an axial narrow opening (312) defined therein. The tube (311) receives the bolt (321) of the male body (32) in a way of allowing the bits (322) to be protruded through the narrow opening (312).

Mounted around the tube (311) of the female body (31) is a set of dials (40) that are retained sequentially thereon by a snap ring (33) at a distal end of the tube (311). Each of the dials (40) includes a dial ring (41), and additionally an inner dead ring (42) carrying a substantially U-shaped hairspring (43).

The dial ring (41) is formed with a stepped hole, consisting of a central hole (412) engaging the tube (311) and a polygonal chamber (411) receiving the inner dead ring (42). The dead ring (42) defines a through-hole (421) non-rotatably engaging with the tube (311), and a notch (422) always aligned with the narrow opening (312) of the tube (311) for receiving one of the bits (322) of the male body (32) therein.

As shown in FIG. 5, the dead ring (42) further has a lateral collar (423) onto which the U-shaped hairspring (43) snappingly engages so that the polygonal chamber (411) of the dial ring (41) is engaged with a pair of convex portions (431) of the hairspring (43).

The engagement of the polygonal chamber (411) with the convex portions (431) of the hairspring (43) enables the dial ring (41) to be turned step-by-step and hence to be positioned exactly at its particular angular position, which is associated with the combination needed to open the lock. However, the dial (40) is very complicated, as it is composed of three parts each of which must be fabricated.

Therefore, it is an objective of the invention to provide a combination lock to mitigate and/or obviate the aforementioned problem.

### SUMMARY OF THE INVENTION

The object of the present invention is to provide a combination lock with a simplified structure.

Other objects, advantages and novel features of the invention will become more apparent from the following detailed description when taken in conjunction with the accompanying drawings.

### BRIEF DESCRIPTION OF THE DRAWINGS

FIG. 1 is a fragmentary exploded perspective view of a combination lock in accordance with the present invention;

FIG. 2 is an end view showing a dial mounted around an outwardly extending tube of a female body included in the combination lock of FIG. 1;

FIG. 3 is an end view showing an alternative tube for the female body of FIG. 2;

FIG. 4 is a fragmentary exploded perspective view of a conventional combination lock; and

FIG. 5 is an end view showing a dial mounted around an outwardly extending tube of a female body included in the conventional combination lock of FIG. 4.

### DETAILED DESCRIPTION OF THE PREFERRED EMBODIMENT

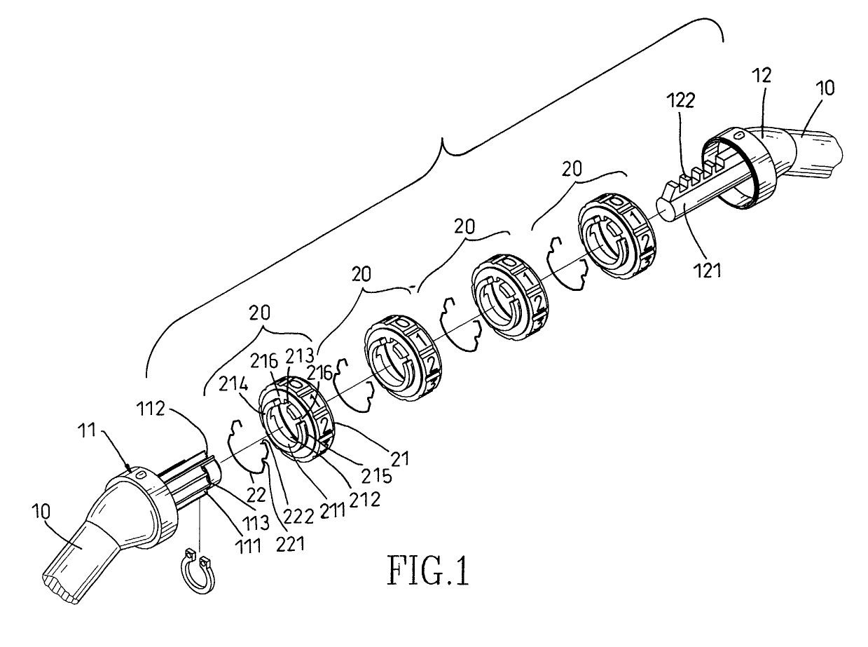

Referring to FIG. 1, a combination lock in accordance with the present invention includes a wire rope (10) with a female body (11) at one end and a male body (12) at the other. The male body (12) has an outwardly extending bolt (121) with an axial row of projecting bits (122) formed thereon.

The female body (11) has an outwardly extending tube (111) with an axial narrow opening (112) defined therein, for the purpose of receiving the outwardly extending bolt (121) of the male body (12) in the tube (111) with the bits (122) protruded from the tube (111) through the narrow opening (112). In the inventive lock, the tube (111) is formed with a plurality of axial groves (113) defined in an outer periphery thereof.

Mounted around the tube (111) of the female body (11) is a set of dials (20), which are retained sequentially thereon by a resilient element, such as a snap ring (13) positioned on the tube (111) at its distal end. Each of the dials (20) includes a dial ring (21) and a substantially U-shaped hairspring (22) carried on the dial ring (21).

The dial ring (21) has a central hole (211), terminating in an enlarged chamber (212) that is used for receiving one of the projecting bits (122) of the male body (12) in spite of any angular position of the ring (21) with respect to the tube (111) of the female body (11). The dial ring (21) further has a notch (213) open radially inward to the central hole (211) and axially to the enlarged chamber (212).

It is through the notch (213) that at least one of the projecting bits (122) can go into and exit from the chamber (212) of the next dial ring (21), only after the ring (21) is turned to a particular angular position in which the notch (213) is aligned with the axial, narrow opening (112) of the tube (111).

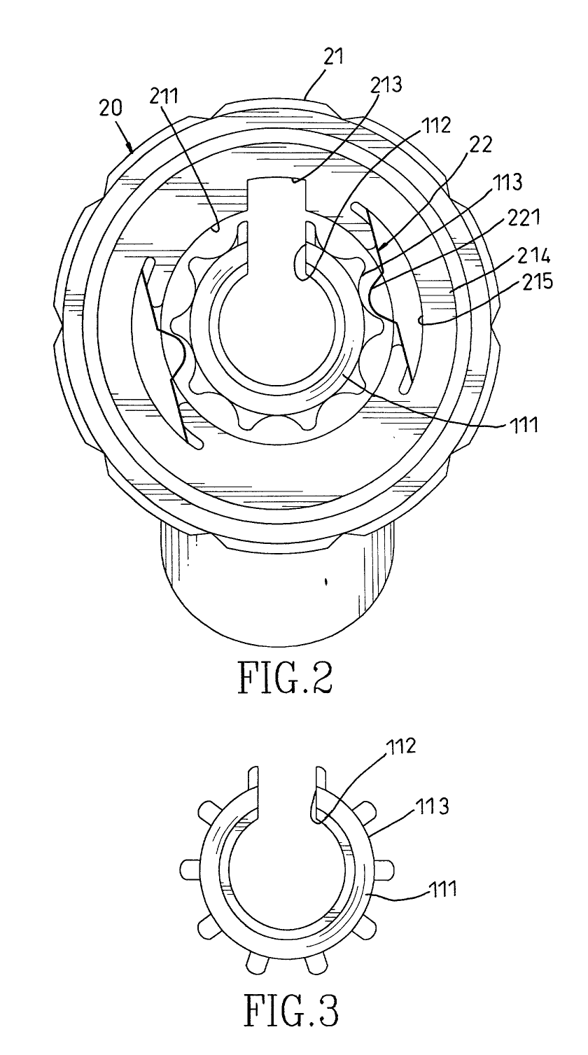

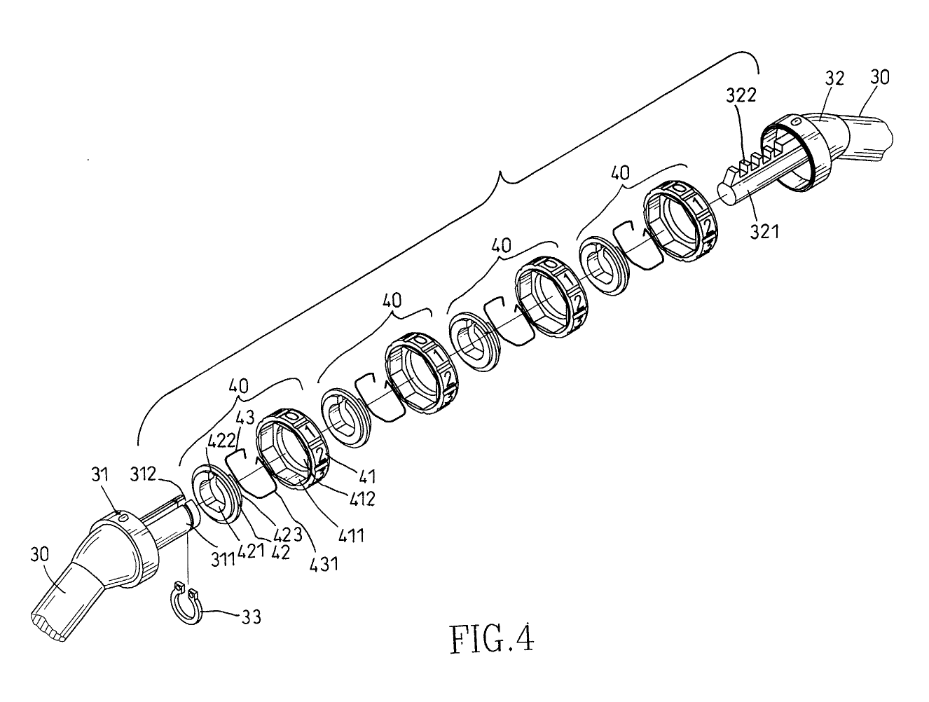

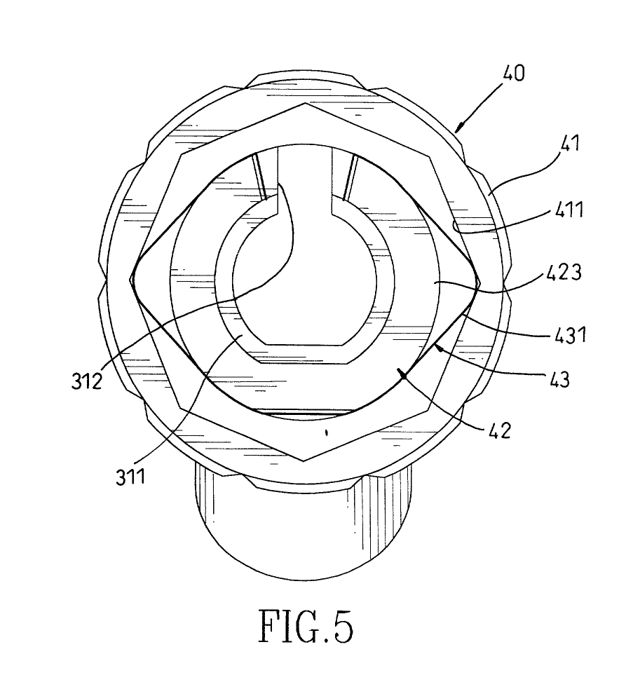

The dial ring (21) is preferably formed with a lateral collar (214) having a pair of radial slots (215) defined therein diametrically. The substantially U-shaped hairspring (22) is snappingly fitted around the collar (214) and has a pair of curved portions (221) extending inward through the radial slots (215) to engage two of the axial grooves (113) of the tube (111), as best seen in FIG. 2.

More preferably, the lateral collar (214) defines a pair of slits (216) therein, and the hairspring (22) has a pair of angled ends (222) securely received in the slits (216), thereby enabling the hairspring (22) to be carried on the dial ring (21).

Referring to FIGS. 2 and 3, the grooves (113) of the tube (11) can be configured in various ways. For example, they may have an inwardly curved shape each in their cross section, as shown in FIG. 2, or alternatively may have a substantially trapezoidal shape in their cross section, as shown in FIG. 3.

With the grooves (113) and the curved portions (221) of the hairspring (22), the dial (20) clicks as it is turned round, which indicates its progress or step-by-step movement relative to the tube(111).

Particularly, the grooves (113) are arranged in a way corresponding to the symbols (either numbers or letters) marked on the dial ring (21), so that the curved portions (221) of the hairspring (22) is engaged with two of the grooves (113) whenever the dial ring (21) is in its particular angular position, i.e. the position in which its notch (213) is aligned with the narrow opening (112) of the tube (111). The step-by-step engagement is helpful to the positioning of the dial (20) exactly at its particular angular position, as known in the prior art.

From the above description, it is noted that the invention has the advantage of being simple in structure, since each of its dials (20) only consists of the ring (20) and the hairspring (22).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A combination lock comprising:
a male body (12) having an outwardly extending bolt (121) with an axial row of projecting bits (122) formed thereon;
a female body (11) having an outwardly extending tube (111) with an axial narrow opening (112) defined therein, said tube (111) being provided for receiving said outwardly extending bolt (121) of said male body (12) in a way of allowing said bits (122) to be protruded therefrom through said axial narrow opening (112), said tube (111) having a plurality of axial grooves (113) defined in an outer periphery thereof;
a set of dials (20) mounted around said tube (111) of said female body (11), each of said dials (20) having a dial ring (21) and a hairspring (22) carried on said dial ring (21), said hairspring (22) having at least one curved portion (221) extending inward to engage one of said axial grooves (113) of said tube (111).

2. The combination lock as claimed in claim 1, wherein said dial ring (21) is formed with a lateral collar (214) having at least one radial slot (215) defined therein, and wherein said curved portion (221) of said hairspring (22) extends inward through said radial slot (215) of said collar (214) to engage one of said axial grooves (113) of said tube (111).

3. The combination lock as claimed in claim 2, wherein said lateral collar (214) has a pair of radial slots (215) defined therein diametrically, and wherein said hairspring (22) is made in a substantially U-shaped configuration and has a pair of curved portions (221) extending inward through said radial slots (215) to engage two of said axial grooves (113) of said tube (111).

4. The combination lock as claimed in claim 3, wherein said lateral collar (214) further has a pair of slits (216) defined therein, and wherein said hairspring (22) has a pair of angled ends (222) securely received in said slits (216) of said collar.

5. The combination lock as claimed in claim 1, wherein each of said grooves (113) has an inwardly curved shape in its cross section.

6. The combination lock as claimed in claim 1, wherein each of said grooves (113) has a substantially trapezoidal shape in its cross section.
